(19) United States
(12) Patent Application Publication
(10) Pub. No.: US 2014/0302707 A1
(43) Pub. Date: Oct. 9, 2014

(54) CABLE ASSEMBLY WITH IMPROVED SHELL

(71) Applicant: HON HAI PRECISION INDUSTRY CO., LTD., New Taipei (TW)

(72) Inventors: JERRY WU, Irvine, CA (US); JUN CHEN, Kunshan (CN); FAN-BO MENG, Kunshan (CN)

(73) Assignee: HON HAI PRECISION INDUSTRY CO., LTD., New Taipei (TW)

(21) Appl. No.: 14/247,491

(22) Filed: Apr. 8, 2014

(30) Foreign Application Priority Data
Apr. 8, 2013 (CN) 2013101189815

(51) Int. Cl. H01R 13/6596

(52) U.S. Cl. CPC H01R 13/6596
USPC 439/386

(57) ABSTRACT

A cable assembly (100) including an insulative housing (2) defining a number of receiving passageways (20), a number of contacts (3) received into the receiving passageways, a cable electrically connected with the contacts, a metallic shell (1) surrounding the insulative housing (2).The contacts comprise a number of grounding contacts and signal contacts and the metallic shell defines a number of metallic plates (1110) extending into the insulative housing to contact the grounding contacts.

### BACKGROUND OF THE INVENTION

1. Field of the Invention

The present invention generally relates to a cable assembly, and more particularly to a cable assembly for transmitting high-speed signals.

2. Description of Related Art

Cross talk phenomenon may occur during signal transmission of a cable assembly as to affect signal quality/performance. For example, U.S. Pat. No. 7,390,220, issued on Jun. 24, 2008 to Wu, discloses a cable connector comprising an insulated housing defining a receiving space, a plurality of terminals arranged into an upper and a lower terminal rows and received in the insulated housing, a spacer located between the upper and lower terminal rows, a metal plate retained in to spacer, and a cable including a number of wires electrically connected to the terminals and the metal plate. The plurality of terminals comprise signal terminals and grounding terminals. The metal plate defines a panel portion received in the spacer and a number of separated claws respectively bent upwardly and downwardly from a rear edge of the panel portion and electrically connected to corresponding grounding terminals. The plurality of grounding terminals achieve a common grounding connection through the panel portion in order to improve signal transmission.

An improved cable assembly is desired.

### SUMMARY OF THE INVENTION

Accordingly, an object of the present invention is to provide a cable assembly with a simple structure to achieve common grounding.

In order to achieve the object set forth, a cable assembly comprises: an insulative housing defining a plurality of receiving passageways and a plurality of through slots in communication with the receiving passageways; a plurality of contacts disposed in the insulative housing and comprising a plurality of grounding contacts; a cable electrically connected with corresponding contacts; and a metallic shell enclosing the insulative housing and defining a plurality of spring tabs, the spring tab extending into the through slot and contacting with the grounding contact.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of a cable assembly in accordance with the present invention;

FIG. 2 is an exploded, perspective view of FIG. 1;

FIG. 3 is a view similar to FIG. 2 but from another perspective;

FIG. 4 is perspective view of a metallic shell of the cable assembly;

FIG. 5 is a cross-sectional view taken along line 5-5 of FIG. 1; and

FIG. 6 is a cross-sectional view taken along line 6-6 of FIG. 1.

### DETAILED DESCRIPTION OF THE INVENTION

Reference will now be made in detail to the preferred embodiment of the present invention.

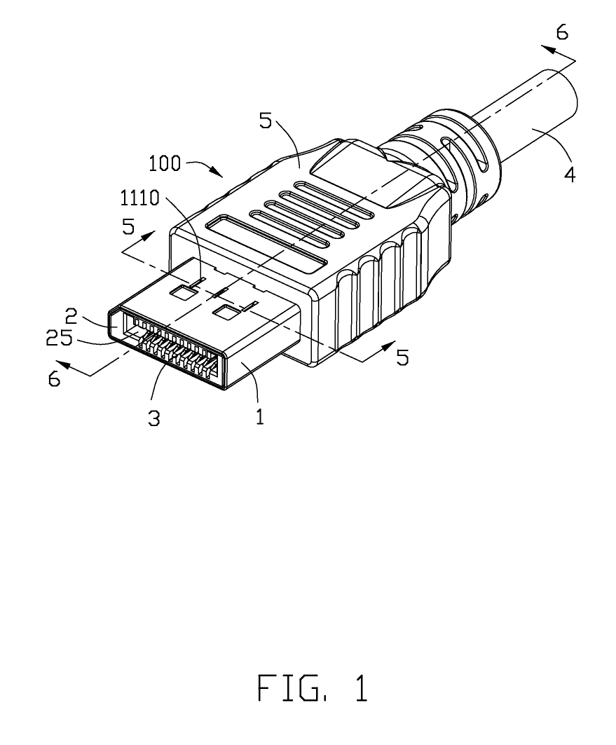

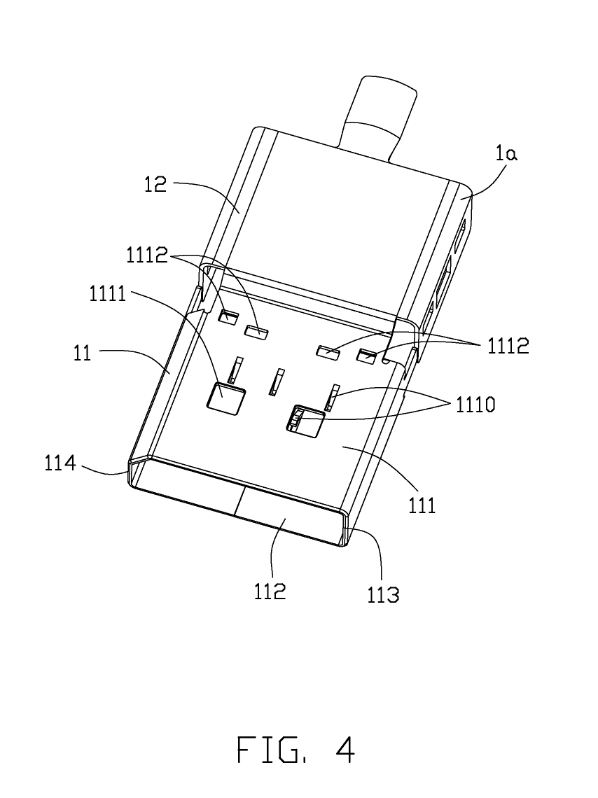

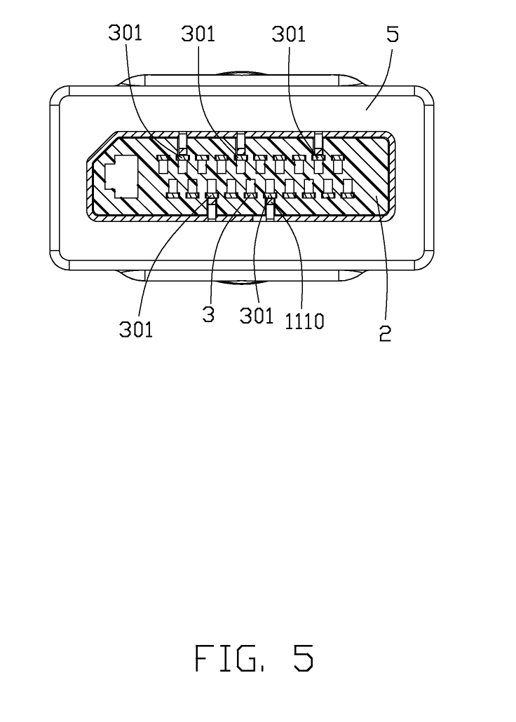

Referring to FIGS. 1-6, a cable assemble 100 comprises an insulative housing 2, a plurality of contacts 3 received in the insulative housing 2, a metallic shell 1 shielding the insulative housing 2, a cable 4 electrically connected with the plurality of contacts 3, and an insulative cover 5 enclosing at least a portion of the metallic shell 1.

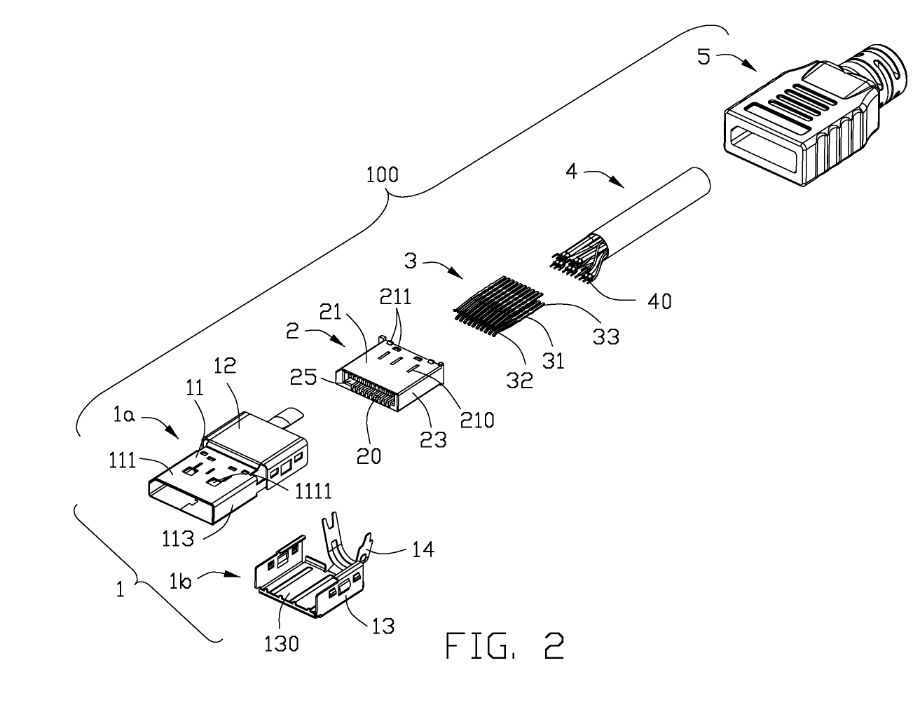

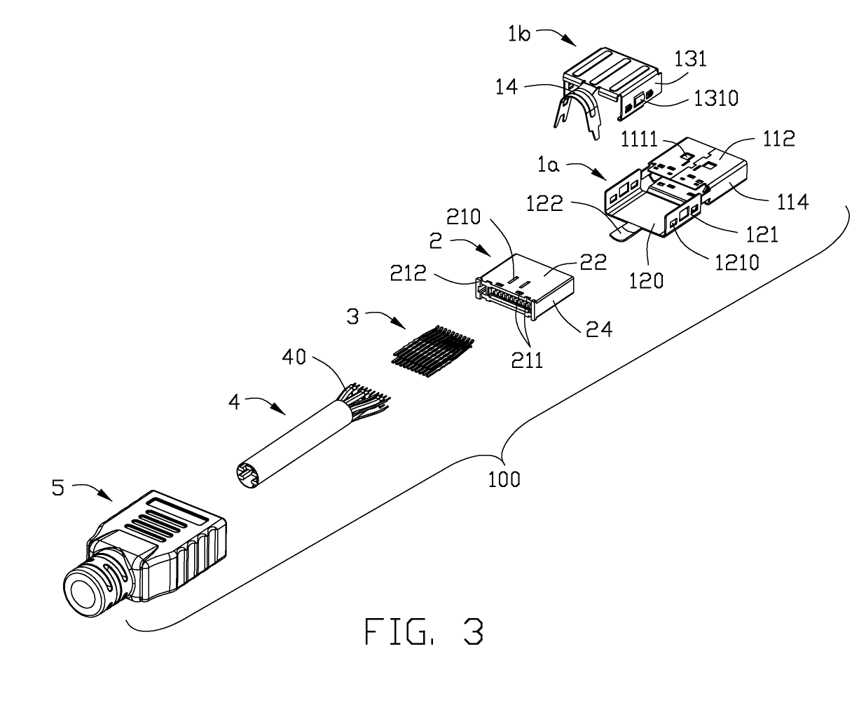

Referring FIGS. 2 and 3, the insulative housing 2 is structured in a rectangular shape and comprises an upper wall 21, an opposite lower wall 22, and a pair of side walls 23, 24 respectively connected between the upper wall 21 and the lower wall 22. The insulative housing 2 defines a receiving space 25 extending rearwardly front a front surface thereof for a distance. The insulative housing 2 defines two rows of receiving passageways 20 respectively formed on inner surfaces of the upper and lower wall and communicated with the receiving space 25. The upper wall 21 and the lower wall 22 of the insulative housing respectively define a plurality of through slots 210 extending along a longitudinal direction and spaced apart from each other along a transversal direction perpendicular to the longitudinal direction. Each of the through slots 210 extends all the way through respective top and bottom surfaces of the upper wall 21 and the lower wall 22 and corresponds to or preferably is in alignment with a receiving passageway 20 along a vertical direction. The receiving space 25 is in fluid communication with an exterior through the plurality of through slots 210. The insulative housing 2 further defines two pairs of protrusions 211 located on a rear portion of the upper wall 21 and the lower wall 22. Each pair of protrusion 211 are arranged symmetrically. The pair of side walls 23, 24 respectively define a projection 12 formed on a rear section thereof

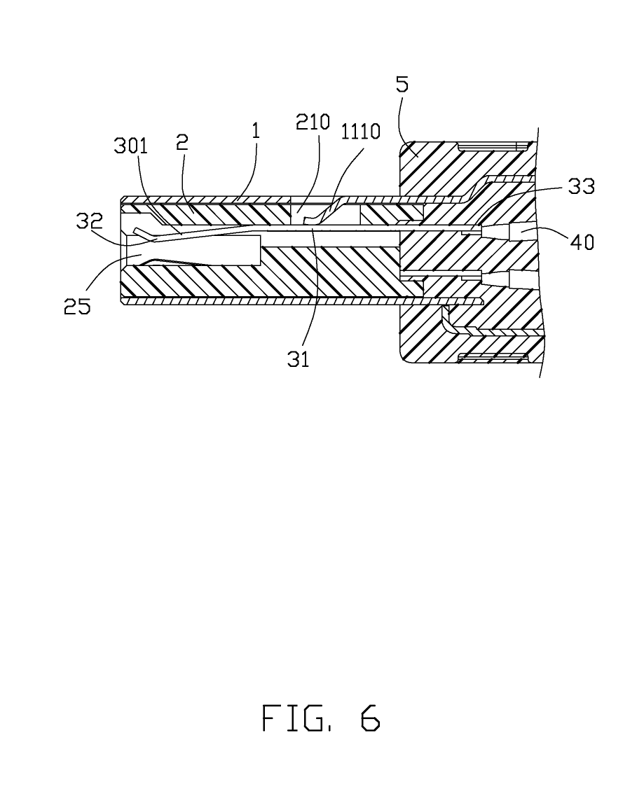

Referring to FIGS. 2 to 4 and in conjunction with FIG. 6, the metallic shell 1 comprises a first shield part la and a second shield part lb assembled with each other along a vertical direction. The first shield part la comprises a front frame portion 11 defining a top side 111, a bottom side 112, and a pair of lateral sides 113, 114 connecting with the top and bottom sides 111, 112 to form a receiving room for receiving the insulative housing 2. The top side 111 and the bottom side 112 respectively define a plurality of spring tabs 1110, e.g., formed by a stamping process, that extend into the receiving room of the front frame portion 11. The top side 111 and the bottom side 112 respectively define two windows 1111 located in front of the spring tabs 110 and four holes 1112 located rearwardly of the spring tabs 1110 for cooperating with the protrusion 211. The plurality of spring tabs 110 respectively extend into corresponding passageways when the insulative housing 2 is received into the metallic shell 1. The first shield part 1a further comprises an n-shaped portion 12 and a supporting section 122 extending rearwardly from the rear end of the n-shaped portion 12. The n-shaped portion 12 comprises a top section 120 and two lateral sections 121 extending downwardly from the two sides of the top section 120. Each lateral section 121 defines three locking holes 1210 arranged in a row along the longitudinal direction. The second shield part lb defines a u-shaped portion 13 and a cable holder 14 extending rearward from a rear portion of the u-shaped portion 13. The u-shaped portion 13 comprises a bottom section 130 and a pair of side sections 131 extending upwardly from the two sides of the bottom section. Each side section 131 defines three locking tabs 1310 cooperated with corresponding locking holes 1210 of the lateral section 121 of the n-shaped portion 12.

Referring to FIGS. 2 to 3 and 5 to 6, the plurality of contacts 3 are divided into two rows. Each row of contacts comprises a plurality of signal contacts and grounding contacts 301. Each of the contacts 3 comprises a flat body portion 31, a curved mating portion 32 extending forwardly from a front end of the flat body portion 31, and a terminating portion 33 extending rearward from a rear end of the flat body portion 31. The plurality of contacts 3 are respectively accommodated in corresponding receiving passageways 20 of the insulative housing 2. The curved mating portions 32 extend into the receiving space 25 and the terminating portions 33 extend beyond a rear surface of the insulative housing 2.

Referring FIGS. 1 to 3 in conjunction with FIG. 6, the cable 4 comprises a plurality of wires 40. The plurality of wires 40 are divided into two rows and electrically connected with corresponding terminating portions 33 of the contacts 3.

The assembling process of the cable assembly 100 made in accordance to preferred embodiment of the present invention 100 will now be described. Firstly, the contacts 3 are received into the insulative housing 2. The flat potions 31 are received into the receiving passageways 20, the curved mating portion 32 are extended into receiving space 25, and the terminating portion 33 extended out of the back face of the insulative housing 2. Secondly, the insulative housing 2 and contacts 3 together are received into the first shield part 1a. The four holes 1112 of the first shield part la cooperate with corresponding protrusions 211 to engage the first shield part la with the insulative housing 2. The plurality of spring tabs 1110 respectively extend into the corresponding through slots 210 and contact with the corresponding grounding contacts 301 located in some of the passageways 20 which are in alignment with through slots 210. Thirdly, the plurality of wires of the cable 4 are respectively soldered to the terminating portions 33 of the contacts 3. Fourthly, the second shield part lb is assembled to the first shield part 1a along a vertical direction. Finally, the insulative cover 5 is formed around the metallic shell 1 by an over-molding process.

After the above assembling steps, the entire process of assembling of the cable assembly 100 is finished. In the present invention, the metallic shell 1 defines a plurality of spring tabs 1110 extending into the insulative housing 2 and electrically connected with the grounding contacts 3. Thus, all grounding contacts 301 of the plurality of contacts are commonly grounded by the metallic shell 1 alone. Meanwhile, the cable assembly 100 has advantages of simple structure and low cost manufacturing.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

What is claimed is:

1. A cable assembly comprising:
an insulative housing defining a plurality of receiving passageways and a plurality of through slots in communication with the receiving passageways;
a plurality of contacts disposed in the insulative housing and comprising a plurality of grounding contacts;
a cable electrically connected with corresponding contacts; and
a metallic shell enclosing the insulative housing and defining a plurality of spring tabs, each of the spring tabs extending into the through slot and contacting with the grounding contact.

2. The cable assembly as claimed in claim 1, wherein the spring tab is integrally formed with the metallic shell by stamping.

3. The cable assembly as claimed in claim 1, wherein the grounding contact extends along a lengthwise direction and the spring tab contacts substantially a middle of the grounding contact along the lengthwise direction.

4. The cable assembly as claimed in claim 1, wherein each of the plurality of contacts comprises a flat body portion, a curved mating portion extending forwardly from a front end of the flat body, and a terminating portion extending rearwardly from a rear end of the flat body portion.

5. The cable assembly as claimed in claim 4, wherein the cable comprises a plurality of wires electrically connected to the terminating portions of the contacts.

6. The cable assembly as claimed in claim 1, wherein the metallic shell comprises a first shield part and a second shield part assembled to the first shield part along a vertical direction.

7. The cable assembly as claimed in claim 6, wherein the first shield part comprises a front frame portion, and the spring tabs are formed on the front frame portion.

8. A cable connector assembly comprising:
an insulative housing defining therein a plurality of passageways extending along a front-to-back direction and in communication with a receiving space;
a plurality of contacts disposed in the corresponding passageways, respectively, each of said contacts defining a front deflectable mating portion extending into the receiving space, a body portion retained in the corresponding slot, and a tail end connected to a corresponding wire of a cable located behind the housing, said contacts being categorize with signal contacts and grounding contacts; and
a metallic shell enclosing the housing and including a plurality of spring tabs extending inwardly through the housing and toward the corresponding passageways in a vertical direction perpendicular to said front-to-back direction to mechanically and electrically connect to the body portions of the corresponding grounding contacts, respectively.

9. The cable connector assembly as claimed in claim 8, wherein the housing forms a plurality of through slots to receive the corresponding spring tabs, respectively.

10. The cable connector assembly as claimed in claim 9, wherein the through slot and the corresponding passageway are located by two sides of the body portion of the corresponding grounding contact in the vertical direction.

11. The cable connector assembly as claimed in claim 8, wherein the shell defines at least one windows for locking with corresponding spring tangs of a complementary connector, and the window is located in front of said spring tabs in said front-to-back direction.

12. The cable connector assemble as claimed in claim 11, wherein said shell further includes a plurality of holes behind the spring tabs to receive corresponding protrusion formed on the housing for securing the housing and the shell together.

13. The cable connector assembly as claimed in claim 8, wherein the spring tabs are unitarily formed with the shell via stamping
